(19) United States
(12) Patent Application Publication
(10) Pub. No.: US 2026/0056699 A1
(43) Pub. Date: Feb. 26, 2026

(54) RADIO COMMUNICATION SYSTEM, CONTROLLER, RADIO PROCESSING DEVICE, AND CONTROL METHOD FOR RADIO COMMUNICATION SYSTEM

(71) Applicant: ICOM INCORPORATED, Osaka (JP)

(72) Inventors: Satoshi MATSUDA, Osaka (JP); Hirofumi YAMAUCHI, Osaka (JP)

(21) Appl. No.: 19/304,839

(22) Filed: Aug. 20, 2025

(30) Foreign Application Priority Data
Aug. 23, 2024 (JP) 2024-143464

(51) Int. Cl. G06F 3/16; H04B 7/26

(52) U.S. Cl. CPC G06F 3/162; H04B 7/26

(57) ABSTRACT

Audio undergone squelch process and audio not undergone squelch process are both dealt with by a controller, while increase in communication traffic or consumed resource in an arithmetic section is prevented. A radio processing device of a radio communication system includes an output control section which outputs, to the controller, a packet including at least one unit audio data and squelch information corresponding to the respective unit audio data and indicating a determination result of a squelch determining section which determines whether to open or close squelch, and the controller includes: an audio data output section outputting, as audio data undergone a process according to squelch information or as audio data not undergone the process according to squelch information, the unit audio data in the packet from the radio processing device.

### CROSS-REFERENCE TO RELATED APPLICATIONS

This Nonprovisional application claims priority under 35 U.S. C. § 119 on Patent Application No. 2024-143464 filed in Japan on Aug. 23, 2024, the entire contents of which are hereby incorporated by reference.

### TECHNICAL FIELD

The present invention relates to a radio communication system including: a radio processing device which processes a high frequency signal transmitted or received by an antenna; and a controller which is communicably connected to the radio processing device and which controls operation of the radio processing device.

### BACKGROUND ART

There has been known a conventional technique for transmitting audio data divided into a plurality of packets. For example, Patent Literature 1 discloses a packet transmitting and receiving device. In transmitting packets, the packet transmitting and receiving device transmits transmission packets of sound data at predetermined intervals. When silence data is input, the packet transmitting and receiving device creates a transmission packet by adding a silence flag so as to follow sound data and further adding dummy data thereto, and transmits the transmission packet thus created. If sound data is input after that, the packet transmitting and receiving device creates a transmission packet by adding a sound flag so as to follow silent dummy data and further adding sound data thereto, and transmits the transmission packet thus created.

### CITATION LIST

### Patent Literature

[Patent Literature 1]

Japanese Patent Application Publication, Tokukaihei, No. H9-64911 (1997)

### SUMMARY OF INVENTION

### Technical Problem

Incidentally, in some cases, a radio device which outputs audio generated by processing a high frequency signal received by an antenna may have a squelch function which prevents output of noise included in the audio.

For example, the radio device configured as above carries out the following process. That is, according to a setting made by a user, the squelch function is enabled so that audio in which noise is silenced is output from a speaker; meanwhile, according to a setting made by a user, the squelch function is not enabled so that audio in which noise is not silenced is stored (recorded) in a storage section. In a radio communication system configured such that a radio device which receives a high frequency signal and carries out a squelch process and a controller which controls the radio device are separated from each other and are communicably connected with each other via, e.g., a Local Area Network (LAN), it is necessary to transmit, from the radio device to the controller, both (i) audio data for which the squelch process is carried out and (ii) audio data for which the squelch process is not carried out. This will lead to increase of communication traffic and increase of consumed resources in an arithmetic section which carries out communication processing.

An aspect of the present invention has an object to deal with, on the controller side, both (i) audio for which the squelch process is carried out and (ii) audio for which the squelch process is not carried out, while preventing increase of communication traffic or increase of consumed resources in an arithmetic section.

### Solution to Problem

In order to attain the above object, a radio communication system in accordance with an aspect of the present invention is a radio communication system including: a radio processing device configured to process a high frequency signal transmitted or received by an antenna; and a controller which is communicably connected to the radio processing device and which is configured to control operation of the radio processing device, the radio processing device including a squelch determining section configured to determine, for each piece of given unit audio data of a decoded signal obtained by decoding the high frequency signal received by the antenna, whether to open or close squelch, the determination being made according to a noise component included in the decoded signal and an output control section configured to output, to the controller, a packet including (i) at least one piece of the unit audio data and (ii) a piece of squelch information which corresponds to a respective one of the at least one piece of the unit audio data and which is indicative of a result of the determination made by the squelch determining section, and the controller including an audio data output section configured to output, as (i) audio data for which a process according to the piece of squelch information is carried out or (ii) audio data for which the process according to the piece of squelch information is not carried out, the at least one piece of the unit audio data included in the packet received from the radio processing device.

In order to attain the above object, a control method for a radio communication system in accordance with an aspect of the present invention is a control method for a radio communication system which includes: a radio processing device configured to process a high frequency signal transmitted or received by an antenna; and a controller which is communicably connected to the radio processing device and which is configured to control operation of the radio processing device, the control method including: a squelch determining step of determining, for each piece of given unit audio data of a decoded signal obtained by decoding the high frequency signal received by the antenna, whether to open or close squelch, the determination being made according to a noise component included in the decoded signal; an output control step of outputting, to the controller, a packet including (i) at least one piece of the unit audio data and (ii) a piece of squelch information which corresponds to a respective one of the at least one piece of the unit audio data and which is indicative of a result of the determination made in the squelch determining step; an audio data output step of outputting, as (i) audio data for which a process according to the piece of squelch information is carried out or (ii) audio data for which the process according to the piece of squelch information is not carried out, the at least one piece of the unit audio data included in the packet received from the radio processing device, the squelch determining step and the output control step being carried out by the radio processing device, and the audio data output step being carried out by the controller.

### Advantageous Effects of Invention

In accordance with an aspect of the present invention, it is possible to deal with, on the controller side, both (i) the audio for which the squelch process is carried out and (ii) the audio for which the squelch process is not carried out, while preventing increase of communication traffic or increase of consumed resources in an arithmetic section.

### BRIEF DESCRIPTION OF DRAWINGS

FIG. 1 is a block diagram illustrating an overview of a radio communication system.

FIG. 2 is a view illustrating an example of a configuration of a packet which is input from a radio processing device to a controller.

FIG. 3 is a flowchart illustrating an example of a control method for the radio communication system.

### DESCRIPTION OF EMBODIMENTS

### First Embodiment

The following description will discuss details of an embodiment of the present invention.

### [Overview of Radio Communication System 1]

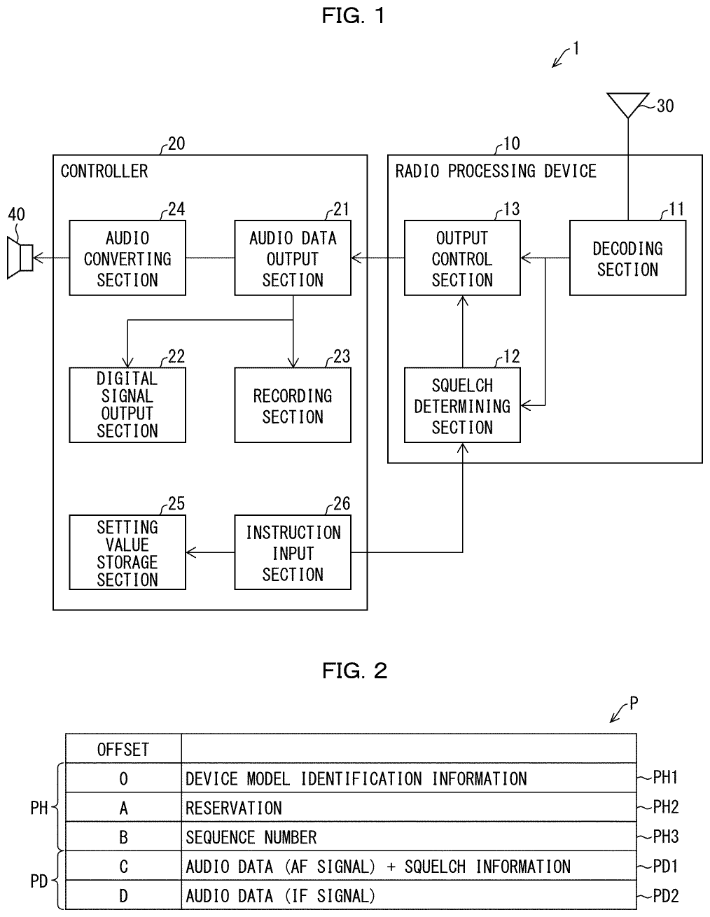

FIG. 1 is a block diagram illustrating an overview of a radio communication system 1. The radio communication system 1 is a system configured to transmit or receive a high frequency signal through radio communication which high frequency signal is obtained by converting an audio signal input via, e.g., a microphone (not illustrated). The radio communication system 1 includes a radio processing device 10 and a controller 20.

The radio processing device 10 is a device configured to process a high frequency signal which is transmitted or received by an antenna 30. The radio processing device 10 includes a decoding section 11, a squelch determining section 12, and an output control section 13.

The decoding section 11 decodes, into an audio signal (Audio Frequency (AF) signal), a high frequency signal received by the antenna 30. The decoding section 11 is constituted by, e.g., an analog/digital (A/D) convertor, a Field Programmable Gate Array (FPGA), and/or the like. The A/D convertor converts an analog signal (high frequency signal) received by the antenna 30 into a digital signal, and inputs the digital signal into the FPGA. The FPGA decodes the input digital signal into an audio signal (decoded signal) according to a given decoding method. The decoding section 11 outputs the decoded signal to the squelch determining section 12 and the output control section 13.

Note that the radio processing device 10 may include a bandpass filter which takes out a specific frequency component from the high frequency signal received by the antenna 30. In this case, the decoding section 11 decodes the high frequency signal which has been input thereto via the bandpass filter. Further, the radio processing device 10 may include a frequency converting circuit which outputs an Intermediate Frequency (IF) signal obtained as a result of converting the high frequency signal received by the antenna 30 into an IF.

The squelch determining section 12 detects a noise component included in the decoded signal. According to the noise component thus detected, the squelch determining section 12 determines, for each piece of given unit audio data of the decoded signal, whether to open or close the squelch. The unit audio data may be a single sample in audio sampling data serving as the decoded signal. For example, a sampling cycle for the decoded signal may be 48 KHz. Further, the unit audio data may be one of pieces of data into which the decoded signal is divided in each predetermined time period.

The squelch determining section 12 determines whether or not a signal intensity of the noise component of the decoded signal is equal to or higher than a predetermined threshold, so as to determine whether to open or close the squelch. In a case where the signal intensity of the noise component is equal to or higher than the threshold, the squelch determining section 12 determines to close the squelch. Meanwhile, in a case where the signal intensity of the noise component is below the threshold, the squelch determining section 12 determines to open the squelch. The squelch determining section 12 outputs, to the output control section 13, the determination result as to whether to open or close the squelch.

The squelch determining section 12 may detect a noise component from a decoded signal amplified by an amplifying circuit, for example. The squelch determining section 12 may detect the noise component in the decoded signal, for example, on the basis of a voltage detected from the amplified decoded signal, the detection being carried out by a voltage detection circuit configured to detect a voltage. Further, the squelch determining section 12 may use, as the signal intensity of the noise component, a voltage value of the voltage detected from the decoded signal. The squelch determining section 12 may determine whether or not a signal intensity of the high frequency signal received by the antenna 30 is equal to or higher than a predetermined value, so as to determine whether to open or close the squelch.

The output control section 13 outputs various pieces of information to the controller 20. The output control section 13 outputs, to the controller 20, a packet P (see FIG. 2) which includes (i) at least one piece of unit audio data and (ii) a piece(s) of squelch information respectively corresponding to the at least one piece of the unit audio data. The squelch information is information which is indicative of a result of determination made by the squelch determining section 12. In a case where the squelch determining section 12 determines to open the squelch, the squelch information includes information for opening the squelch. Meanwhile, in a case where the squelch determining section 12 determines to close the squelch, the squelch information includes information for closing the squelch. The output control section 13 incorporates, into a piece of given unit audio data of the decoded signal input from the decoding section 11, a piece of squelch information corresponding to the piece of the given unit audio data. The output control section 13 packetizes, into a packet P, a piece of unit audio data including at least one piece of squelch information, and outputs the packet P to the controller 20.

The controller 20 is a controller which is communicably connected with the radio processing device 10 and which is configured to control operation of the radio processing device 10. The controller 20 is a device which is physically separated from the radio processing device 10. The controller 20 is communicably connected with the radio processing device 10. The controller 20 carries out communication with the radio processing device 10 via a communication line such as a Local Area Network (LAN) or the like. The controller 20 and the radio processing device 10 are communicably connected with each other either via wired connection or wireless connection. The controller 20 includes an audio data output section 21, a digital signal output section 22, a recording section 23, an audio converting section 24, a setting value storage section 25, and an instruction input section 26.

The audio data output section 21 outputs, as audio data, the piece of unit audio data included in the packet P received from the output control section 13 of the radio processing device 10. The audio data which is output from the audio data output section 21 is (i) audio data for which a process is carried out according to a piece of squelch information corresponding to a respective piece of unit audio data included in the packet P received from the output control section 13 or (ii) audio data for which the process according to the piece of squelch information is not carried out.

In a case where the process according to the pieces of squelch information is carried out with respect to audio data which is to be output, the audio data output section 21 carries out a process for opening the squelch with respect to a piece of unit audio data included in a packet P including, as a pieces of squelch information, information for opening the squelch. Meanwhile, the audio data output section 21 carries out a process for closing the squelch with respect to a piece of unit audio data included in a packet P including, as a piece of squelch information, information for closing the squelch. That is, in a case where the process according to the pieces of squelch information is carried out with respect to audio data which is to be output, audio data in which a part of noise is silenced is output.

Further, in a case where the process according to the pieces of squelch information is not carried out with respect to audio data which is to be output, the audio data output section 21 outputs audio data for which the squelch is opened, regardless of the piece of squelch information included in the packet P. That is, in a case where the process according to the pieces of squelch information is not carried out with respect to audio data which is to be output, audio data in which noise is not silenced is output.

The audio data output section 21 outputs the audio data to at least one selected from the group consisting of the digital signal output section 22, the recording section 23, and the audio converting section 24. The digital signal output section 22 outputs, as a digital signal, the audio data which is output from the audio data output section 21. The digital signal which is output from the digital signal output section 22 is a signal for transmitting the audio data to an external device which is outside the radio communication system 1. The digital signal from the digital signal output section 22 is output, for example, via a Sony Philips Digital InterFace (S/PDIF) terminal, a Universal Serial Bus (USB) terminal, a LAN connection terminal, or the like. The recording section 23 records, in an external storage medium, the audio data which is output from the audio data output section 21. Examples of the external storage medium include an SD memory card and a USB memory. The recording section 23 may record, in a storage section (internal storage medium) integrated in the controller 20 such as a Random Access Memory (RAM), the audio data which is output from the audio data output section 21.

The audio converting section 24 converts, into an analog audio signal, the audio data which is output from the audio data output section 21. The audio converting section 24 controls a digital/analog (D/A) convertor. The audio converting section 24 outputs, to the speaker 40, the analog audio signal (AF signal) obtained as a result of the conversion. Note that the audio converting section 24 is not limited to the configuration which outputs the analog audio signal to the speaker 40. Alternatively, for example, the audio converting section 24 may output, to a headphone, the analog audio signal obtained as a result of the conversion. Further, the audio converting section 24 may control the amplifying circuit so as to amplify the analog audio signal obtained as a result of the conversion carried out by the audio converting section 24.

The setting value storage section 25 records, in the internal storage medium of the controller 20, a setting as to whether to carry out, with respect to unit audio data, a process according to squelch information.

The instruction input section 26 accepts inputs of various instructions given by user operation with respect to, e.g., a button and/or a knob (not illustrated) provided to the controller 20. The instruction input section 26 may accept, for each output destination of the audio data, a setting as to whether to carry out, with respect to unit audio data, a process according to squelch information. This setting is stored, by the setting value storage section 25, in the internal storage medium of the controller 20. On the basis of this setting, the audio data output section 21 determines whether to carry out, with respect to unit audio data, a process according to squelch information, the process corresponding to an output destination of the audio data.

The instruction input section 26 may input, into the squelch determining section 12 of the radio processing device 10, the setting for the squelch accepted by user operation, for example. The setting for the squelch may include a setting for adjusting, in determining as to whether to open or close the squelch, a threshold for determining a noise component included in a decoded signal. That is, an intensity level of noise to be silenced in the audio data may be adjusted by adjusting the threshold for determining the noise component.

According to the setting for each output destination of the audio data which setting is made by the user, the audio data output section 21 may switch between (i) outputting unit audio data as audio data for which a process according to squelch information is carried out and (ii) outputting the unit audio data as audio data for which the process according to the squelch information is not carried out. According to an instruction from the instruction input section 26, the audio data output section 21 switches, for each output destination of the audio data, whether or not to carry out the process according to the squelch information. For example, assume that the user has made a setting for preventing noise from being included in the audio data output from the speaker 40 and allowing noise to be included in the audio data recorded in the external storage medium. In this case, (a) the audio data output section 21 outputs unit audio data for which a process according to squelch information is carried out to the audio converting section 24 as audio data, and (b) the audio data output section 21 outputs unit audio data for which a process according to squelch information is not carried out to the recording section 23 as audio data.

Note that FIG. 1 only illustrates the configuration in which the audio signal received by the radio processing device 10 through radio communication is output by the controller 20. Illustration and explanation are omitted for a configuration in which audio input by the controller 20 via a microphone (not illustrated) is wirelessly transmitted from the radio processing device 10 via the antenna 30.

### [Configuration of Packet P]

The following description will discuss, with reference to FIG. 2, an example of a configuration of the packet P for use in the radio communication system 1. FIG. 2 is a view illustrating an example of a configuration of the packet P which is input from the radio processing device 10 to the controller 20.

As shown in FIG. 2, the packet P is constituted by a header part PH and a data part PD. The header part PH may include device model identification information PH1, reservation PH2, and a sequence number PH3. The data part PD includes audio data PD1 made of an AF signal. The data part PD may further include audio data PD2 made of an IF signal. In the present embodiment, the packet P includes the device model identification information PH1, the reservation PH2, the sequence number PH3, the audio data PD1, and the audio data PD2 in this order.

The device model identification information PH1 is a number indicative of (i) a device model constituting the radio communication system 1 and (ii) an input source and an output destination of the packet P. The reservation PH2 is an area prepared for future expansion of a data use area. The sequence number PH3 is a number indicative of the order of input of pieces of data.

The audio data PD1 is data generated as a result of dividing the decoded signal (AF signal) in specific time periods. For example, the decoded signal is divided in units of 500 μs, so as to generate one or more pieces of audio data PD1. The audio data PD1 includes a plurality of samples. That is, one packet P includes a plurality of samples. The audio data PD1 includes one or more pieces of squelch information. In the audio data PD1, each of the samples included therein may be associated with a respective piece of squelch information. In this case, assume that a size of one sample is 32 bits, for example. Then, high-order 24 bits of the 32 bits are allocated to data representing audio data, whereas lower-order 8 bits of the 32 bits are allocated to squelch information, that is, a flag indicative of opening or closing of the squelch.

Note that a plurality of samples included in the audio data PD1 may be associated with a single piece of squelch information. Further, in a case where the number of pieces of squelch information included in the audio data PD1 is one, a lower bit(s) of the audio data PD1 is/are allocated to a flag indicative of squelch information. In this case, the unit audio data is a group of a plurality of samples associated with a single piece of squelch information.

The audio data PD2 is data generated as a result of dividing, in specific time periods, the audio data made of an IF signal. The audio data PD2 includes a plurality of samples. The audio data PD2 is data which does not include squelch information and for which a process according to squelch information does not need to be carried out. The audio data PD2 is data which is to be input into the controller 20 (i) as audio data to be displayed on a monitor of the radio communication system 1 or (ii) as audio data for recording.

### [Control Method for Radio Communication System 1]

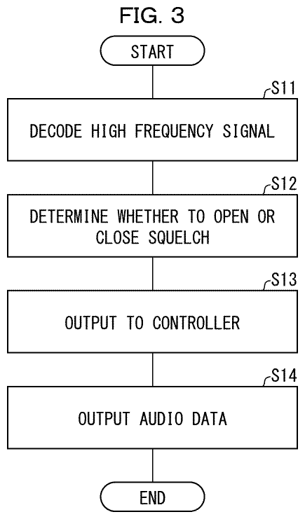

The following description will discuss, with reference to FIG. 3, an example of a control method for the radio communication system 1. FIG. 3 is a flowchart illustrating an example of the control method for the radio communication system 1.

In step S11, when a high frequency signal is received by the antenna 30, the decoding section 11 decodes the high frequency signal thus received. In step S11, the decoding section 11 outputs, to the squelch determining section 12 and the output control section 13, a decoded signal obtained by decoding the high frequency signal.

In step S12, according to a noise component included in the decoded signal thus input, the squelch determining section 12 determines, for each piece of given unit audio data of the decoded signal, whether to open or close the squelch. Step S12 is one example of a squelch determining step. In step S12, the squelch determining section 12 outputs, to the output control section 13, a piece(s) of squelch information indicative of a result of the determination as to whether to open or close the squelch.

In step S13, the output control section 13 outputs, to the audio data output section 21, a packet P including (i) at least one piece of unit audio data and (ii) a piece of squelch information which corresponds to a respective one of the at least one piece of the unit audio data and which is indicative of a result of the determination made in step S12. Step S13 is one example of an output control step.

In step S14, the audio data output section 21 outputs the at least one piece of the unit audio data included in the packet P received from the output control section 13 as (i) audio data for which a process according to the piece of squelch information is carried out or (ii) audio data for which the process according to the piece of squelch information is not carried out. Step S14 is one example of an audio data outputting step. In step S14, according to a setting for each output destination of the audio data which setting is made by a user, the audio data output section 21 may switch between (i) outputting the at least one piece of the unit audio data as the audio data for which the process according to the piece of squelch information is carried out and (ii) outputting the at least one piece of the unit audio data as the audio data for which the process according to the piece of squelch information is not carried out. In step S14, the audio data output section 21 outputs the audio data to at least one selected from the group consisting of the digital signal output section 22, the recording section 23, and the audio converting section 24.

According to the above-described radio communication system 1 and the above-described control method for the radio communication system 1, the radio processing device 10 transmits, to the controller 20, a packet P including unit audio data to each of which respective squelch information is given. With this, it is possible to deal with, on the controller 20 side, both (i) audio for which the squelch process is carried out and (ii) audio for which the squelch process is not carried out, while preventing increase of communication traffic or increase of consumed resources in an arithmetic section.

Further, since the unit audio data and its corresponding squelch information are included in the same packet P, the unit audio data and the squelch information can be received on the controller 20 side at the same timing. With this, it is possible to prevent a situation in which erroneous squelch control is carried out due to deviation between (i) a timing of reception of the unit audio data and (ii) a timing of reception of the squelch information.

The unit audio data is a sample in audio sampling data serving as the decoded signal. Thus, for example, in a case where the radio processing device 10 is configured such that an audio signal processing circuit configured to carry out a decoding process of a high frequency signal and a determining process of determining whether to open or close the squelch carries out a process in a sample unit, the output control section 13 may (i) packetize an output from the audio signal processing circuit as it is and (ii) transmit the packetized output. This makes it possible to simplify the process carried out in the output control section 13.

Further, switching of whether or not to carry out the process according to squelch information with respect to unit audio data is carried out for each output destination of audio data. Consequently, according to the output destination of the audio data, a user can make an appropriate setting as to whether (i) audio data for which the process according to the squelch information is carried out is output or (ii) audio data for which the process according to the squelch information is not carried out is output.

### [Software Implementation Example]

The functions of the controller 20 (hereinafter referred to as a “device”) can be realized by a program for causing a computer to function as the device and for causing the computer to function as control blocks of the device.

In this case, the device includes, as hardware for executing the program, a computer which includes (i) at least one control device (e.g., processor) and (ii) at least one storage device (e.g., memory). By the control device and the storage device executing the program, the functions described in the foregoing embodiments are realized.

The program may be stored in one or more non-transitory and computer-readable storage media. The one or more storage media may or may not be provided to the device. In the latter case, the program may be supplied to the device via any wired or wireless transmission medium.

Further, some or all of the functions of the control blocks can be realized by a logic circuit. For example, the present invention encompasses, in its scope, an integrated circuit (which may be a Field-Programmable Gate Array (FPGA), a Digital Signal Processor (DSP), and/o the like) in which a logic circuit that functions as each of the control blocks is formed. In addition, the function of each of the control blocks can be realized by, for example, a quantum computer.

Aspects of the present invention can also be expressed as follows:
A radio communication system in accordance with a first aspect of the present invention is a radio communication system including: a radio processing device configured to process a high frequency signal transmitted or received by an antenna; and a controller which is communicably connected to the radio processing device and which is configured to control operation of the radio processing device, the radio processing device including a squelch determining section configured to determine, for each piece of given unit audio data of a decoded signal obtained by decoding the high frequency signal received by the antenna, whether to open or close squelch, the determination being made according to a noise component included in the decoded signal and an output control section configured to output, to the controller, a packet including (i) at least one piece of the unit audio data and (ii) a piece of squelch information which corresponds to a respective one of the at least one piece of the unit audio data and which is indicative of a result of the determination made by the squelch determining section, and the controller including an audio data output section configured to output, as (i) audio data for which a process according to the piece of squelch information is carried out or (ii) audio data for which the process according to the piece of squelch information is not carried out, the at least one piece of the unit audio data included in the packet received from the radio processing device.
A radio communication system in accordance with a second aspect of the present invention may be configured such that, in the first aspect, the unit audio data is a sample in audio sampling data serving as the decoded signal.
A radio communication system in accordance with a third aspect of the present invention may be configured such that, in the first aspect, the audio data output section switches, according to a setting for each output destination of the audio data which setting is made by a user, between (i) outputting the at least one piece of the unit audio data as the audio data for which the process according to the piece of squelch information is carried out and (ii) outputting the at least one piece of the unit audio data as the audio data for which the process according to the piece of squelch information is not carried out.
A radio communication system in accordance with a fourth aspect of the present invention may be configured such that, in the third aspect, the each output destination is at least one selected from the group consisting of: an audio converting section configured to convert the audio data into an analog audio signal; a digital signal output section configured to output the audio data as a digital signal; and a recording section configured to record the audio data in an external storage medium.
A controller in accordance with a fifth aspect of the present invention may be configured to be included in the radio communication system in accordance with any one of the first to fourth aspects.
A radio processing device in accordance with a sixth aspect of the present invention may be configured to be included in the radio communication system in accordance with any one of the first to fourth aspects.
A control method for a radio communication system in accordance with a seventh aspect of the present invention is a control method for a radio communication system which includes: a radio processing device configured to process a high frequency signal transmitted or received by an antenna; and a controller which is communicably connected to the radio processing device and which is configured to control operation of the radio processing device, the control method including: a squelch determining step of determining, for each piece of given unit audio data of a decoded signal obtained by decoding the high frequency signal received by the antenna, whether to open or close squelch, the determination being made according to a noise component included in the decoded signal; an output control step of outputting, to the controller, a packet including (i) at least one piece of the unit audio data and (ii) a piece of squelch information which corresponds to a respective one of the at least one piece of the unit audio data and which is indicative of a result of the determination made in the squelch determining step; an audio data output step of outputting, as (i) audio data for which a process according to the piece of squelch information is carried out or (ii) audio data for which the process according to the piece of squelch information is not carried out, the at least one piece of the unit audio data included in the packet received from the radio processing device, the squelch determining step and the output control step being carried out by the radio processing device, and the audio data output step being carried out by the controller.

The present invention is not limited to the embodiments, but can be altered by a skilled person in the art within the scope of the claims. The present invention also encompasses, in its technical scope, any embodiment derived by combining technical means disclosed in differing embodiments.

### REFERENCE SIGNS LIST

1: radio communication system
10: radio processing device
11: decoding section
12: squelch determining section
13: output control section
20: controller
21: audio data output section
22: digital signal output section
23: recording section
24: audio converting section
25: setting value storage section
26: instruction input section
30: antenna
40: speaker

1. A radio communication system comprising:
a radio processing device configured to process a high frequency signal transmitted or received by an antenna; and
a controller which is communicably connected to the radio processing device and which is configured to control operation of the radio processing device,
the radio processing device including
a squelch determining section configured to determine, for each piece of given unit audio data of a decoded signal obtained by decoding the high frequency signal received by the antenna, whether to open or close squelch, the determination being made according to a noise component included in the decoded signal and
an output control section configured to output, to the controller, a packet including (i) at least one piece of the unit audio data and (ii) a piece of squelch information which corresponds to a respective one of the at least one piece of the unit audio data and which is indicative of a result of the determination made by the squelch determining section, and
the controller including
an audio data output section configured to output, as (i) audio data for which a process according to the piece of squelch information is carried out or (ii) audio data for which the process according to the piece of squelch information is not carried out, the at least one piece of the unit audio data included in the packet received from the radio processing device.

2. The radio communication system according to claim 1, wherein:
the unit audio data is a sample in audio sampling data serving as the decoded signal.

3. The radio communication system according to claim 1, wherein:
the audio data output section switches, according to a setting for each output destination of the audio data which setting is made by a user, between (i) outputting the at least one piece of the unit audio data as the audio data for which the process according to the piece of squelch information is carried out and (ii) outputting the at least one piece of the unit audio data as the audio data for which the process according to the piece of squelch information is not carried out.

4. The radio communication system according to claim 3, wherein:
the each output destination is at least one selected from the group consisting of:
an audio converting section configured to convert the audio data into an analog audio signal;
a digital signal output section configured to output the audio data as a digital signal; and
a recording section configured to record the audio data in an external storage medium.

5. A controller included in a radio communication system recited in claim 1.

6. A radio processing device included in a radio communication system recited in claim 1.

7. A control method for a radio communication system which includes: a radio processing device configured to process a high frequency signal transmitted or received by an antenna; and a controller which is communicably connected to the radio processing device and which is configured to control operation of the radio processing device, the control method comprising:
a squelch determining step of determining, for each piece of given unit audio data of a decoded signal obtained by decoding the high frequency signal received by the antenna, whether to open or close squelch, the determination being made according to a noise component included in the decoded signal;
an output control step of outputting, to the controller, a packet including (i) at least one piece of the unit audio data and (ii) a piece of squelch information which corresponds to a respective one of the at least one piece of the unit audio data and which is indicative of a result of the determination made in the squelch determining step;
an audio data output step of outputting, as (i) audio data for which a process according to the piece of squelch information is carried out or (ii) audio data for which the process according to the piece of squelch information is not carried out, the at least one piece of the unit audio data included in the packet received from the radio processing device,
the squelch determining step and the output control step being carried out by the radio processing device, and
the audio data output step being carried out by the controller.
